(19) United States
(12) Patent Application Publication
(10) Pub. No.: US 2002/0042736 A1
(43) Pub. Date: Apr. 11, 2002

(54) Universal product information lookup and display system

(76) Inventors: Ynjiun P. Wang, Cupertino, CA (US); Timothy P. O'Hagan, Akron, OH (US)

Correspondence Address: Daniel R. McGlynn, Telxon Corporation, One Symbol Plaza MS: A-6, Holtsville, NY, 11742-1300, US

(21) Appl. No.: 10/016,001

(22) Filed: Dec. 10, 2001

Related U.S. Application Data
(63) Continuation of application No. 08/752,301, filed on Nov. 19, 1996.
Application No. 08/752,301 is a continuation-in-part of application No. 08/744,109, filed on Nov. 5, 1996.

(51) Int. Cl. G06F 17/60

(52) U.S. Cl. 705/10

(57) ABSTRACT

A system for automated remote retrieval and display of product specific information includes a bar code reader for scanning uniform product code information, or other suitable indicia from a product. This information is decoded via local mapping, remote mapping done by a mapping server, or direct correlation with a network address. Such decoding allows for immediate and automated access to product specific information which is obtained, communicated to a user terminal, and displayed. Use of hypertext-based displays allow a consumer to provide additional querying specific to that particular product to obtain further or specified information. Demographic information specific to a user is suitably obtained to provide valuable market information for the product manufacturers.

### BACKGROUND OF THE INVENTION

This application is a continuation of U.S. patent application Ser. No. 08/752,301, filed on Nov. 19, 1996, which is a continuation-in-part of U.S. Pat. application Ser. No. 08/744,109, filed on Nov. 5, 1996.

This application pertains to the art of database access for consumer products and will be described with particular reference thereto. However, it will be appreciated that the invention has further application in any selective retrieval and display of product information.

The growth of the global Internet has created an entirely new paradigm for information retrieval and display. The growth of the Internet has accelerated substantially due to increasing use for business applications. The original use of the Internet was relegated to universities and large research institutions. However, with the increasing power and decreasing costs of personal computing devices, as well as low-cost connectivity through Internet service providers (“ISPs”), commercial application of the Internet to consumer products is becoming a next level of Internet evolution.

Ubiquitous accessibility of the Internet to consumers has also been substantially aided by the growth of the World Wide Web which provides an intuitive, graphical interface for the Internet. The Internet is also expanding to include multi-media applications, such as including full sound, motion, and virtual reality output.

Many manufacturers of consumer products now have World Wide Web sites which contain information regarding their products. A consumer may obtain such information from his or her home if he or she has a computer with Internet access. Obtaining such information typically involves loading web browser software which is compatible with the chosen Internet service provider, onto the computer and connecting to the Internet service provider or other appropriate means via a modem or an ISDN Bridge/Router. Once connected, the consumer must determine the Internet address of the web site that contains the product information. In some cases the manufacturer may print the web site address, or domain name, on the product or associated marketing literature. In such a case, the consumer would use the keyboard to type the web site address or domain name into the appropriate field in the software information. This field is usually designated as the universal resource locator (“URL”) field. The software then generates data packet information which is transmitted to the server which has the web site data. In response to this packet data, the server transmits the web site data to the consumer's computer.

If the web site address is not printed on the product or marketing literature, the consumer may use one of the various Internet search engines to locate an existing web site address. In this case, the consumer uses the keyboard to type a search term into the appropriate field of the search services form page. The search service then provides the consumer with an Hypertext Markup Language (“HTML”) page which includes links to a list of web sites which match the search parameters. Usually the output of web sites is ranked in descending order determined by the number of times the search term is found. The consumer uses his or her intuition to choose the appropriate web site link from the list of matches. The web browser software then generates the data packet to the server which has the chosen web site data.

There exists a need for a more consumer friendly system for accessing data from an Internet web site which contains data associated with a manufacturer's product.

The subject invention overcomes the above-noted problems, and more, and provides a cost effective, user-friendly system by which a consumer may obtain additional information specific to a manufacturer's product using a substantial amount of pre-existing hardware and software.

### SUMMARY OF THE INVENTION

In accordance with the present invention, there is provided a system for remote display of product specific information which includes a user terminal. The user terminal is provided with a transducer which functions to selectively receive identification information from product indicia, such as uniform product code (“UPC”) information, from an associated product. The user terminal provides a mechanism to disclose such indicia information and communicate it to an associated, remote database system. Information associated with the decoded information is communicated back to the user terminal which provides a means by which such information may be displayed in a humanly-cognizable output. The system further provides for a selective receipt of secondary queries from a user and communication of these queries to the database system for retrieval of further, related information.

In accordance with another aspect of the present invention, there is provided a wide-area network (“WAN”) which functions as a communication mechanism for transmitting data between the user terminal and the associated remote database.

In accordance with another aspect of the present invention, there is provided a system for correlating product code information and product information in a database for receiving selective queries and generating an associated output therefrom.

Further in accordance with still another aspect of the present invention, there is provided an addressing scheme which correlates a location of a database bearing specified product information relating to product code information to allow for obtaining, transmission, and display thereof.

Still further in accordance with another aspect of the present invention is the provision of a mechanism for obtaining additional user queries to allow for obtaining of more specialized or refined information from earlier information transmitted to the user from a database.

Still further in accordance with another aspect of the present invention, there is provided a system for obtaining demographic information relative to a user seeking product information from the system as described above.

Yet another aspect of the present invention is the provision of a method for accomplishing the foregoing.

An advantage of the present invention is the provision of a fast, easy-to-use mechanism by which manufacturers may supply product information to their consuming public quickly and inexpensively.

Another advantage of the present invention is provision of a data query and acquisition system for product information that largely utilizes an already existing hardware and software infrastructure.

An additional advantage of the present invention is the provision of a system for acquiring demographic information relative to consumers.

Still other advantages and benefits of the invention will become apparent to those skilled in the art upon a reading and understanding of the following detailed description.

### BRIEF DESCRIPTION OF THE DRAWINGS

The invention may take physical form in certain parts and arrangements of parts, preferred and alternative embodiments and method of which will be described in detail in this specification and illustrated in the accompanying drawings which form a part hereof, and wherein:

FIG. 1 is a block diagram of the universal product information system of the present invention;

FIG. 2 is a flowchart detailing operation of the selective user query, information retrieval, transmission, and display of the present invention;

FIG. 3 is a flowchart detailing the database address retrieval and UPC code correlation of the subject invention;

FIG. 4 is a diagram of the overall computer-based product information lookup and display system of the subject invention; and

FIG. 5 illustrates a mapping function and domain name translation employed by the subject invention.

### DETAILED DESCRIPTION OF THE PREFERRED EMBODIMENT

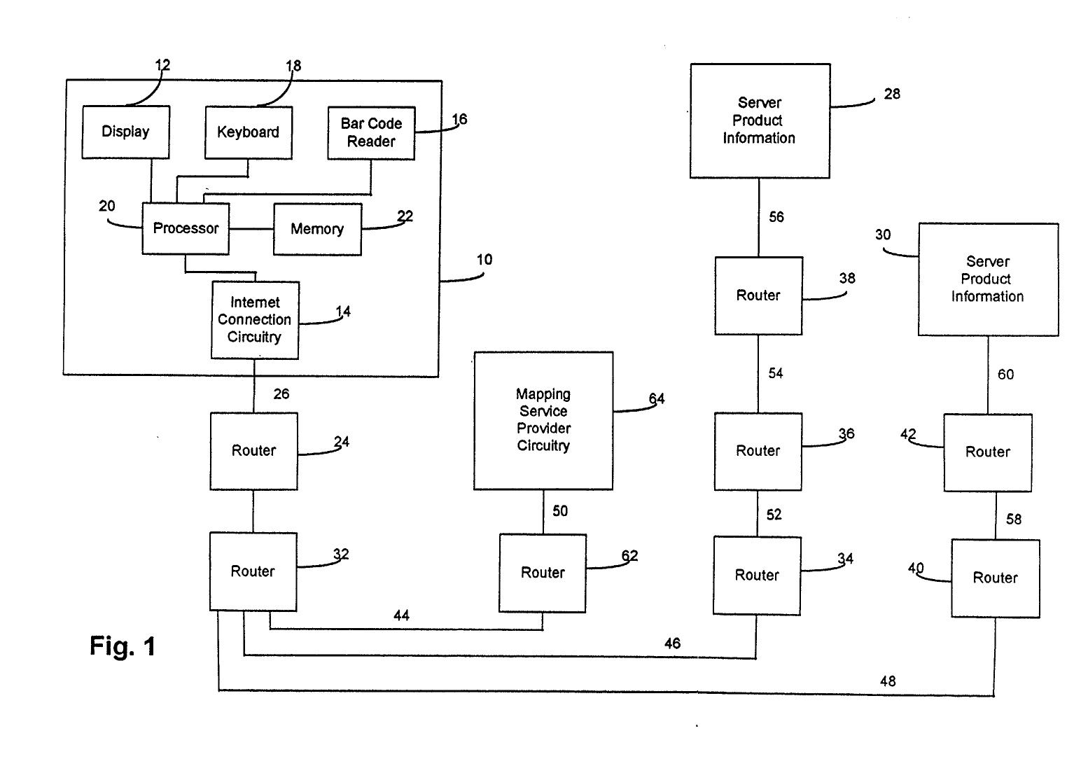

Referring now to the drawings wherein the showings are for the purposes of illustrating the preferred embodiment of the invention only and not for purposes of limiting the same, FIG. 1 is a block diagram which can be used to describe the overall operation of the present invention. A consumer terminal 10 is provided in the consumer's home or place of business. While other embodiments will be discussed later, one embodiment of the consumer terminal 10 could be a personal computer (“PC”) with web browser software as discussed in the background. It will be appreciated that web browsers are available for virtually any computer platform capable of running a communications session. While most web browsers employ a graphical user interface (“GUI”), such as WINDOWS, UNIX, LINUX, MACINTOSH, or AMIGA computers, text-based browsers, such as LYNX, are also common. As used herein, “PC” shall mean any such computer. The PC includes a processor 20 for executing web browser software stored in memory 22. The processor is also coupled to a display 12, a keyboard 18, and Internet connection circuitry 14 which is suitably a Plain Old Telephone Service (“POTS”) modem, ISDN Bridge/Router, or other appropriate means to connect to a router 24 by an appropriate communication link 26 which is suitably a POTS telephone line or an ISDN line (T1 or T3 type), to a wide-area network (“WAN”), internet, or in the preferred embodiment, to the global Internet. Optionally, a bar code scanner 16 is suitably coupled to the PC via keyboard wedge interface circuitry.

The router 24 will typically be connected to the various servers, which are graphically represented at 28 and 30, by a series of routers which are graphically represented at 32, 34, 36, 38, 40, and 42, such routers act on header information in each IP packet to route such information between source and destination computers. The Internet computers or “nodes” are interconnected by various communication links which are graphically represented by 46, 48, 52, 54, 56, 58, and 60.

In operation, the consumer may obtain web site data from either server 28 or 30 by entering the web site address or domain name into the appropriate browser software field. When the web site (“WS”) address is entered, the consumer terminal 10 then transmits one or more Transmission Control Protocol/Internet Protocol (“TCP/IP”) data packets, each of which includes packet header information to facilitate routing, to the router 24 which subsequently routes the data packets to the appropriate server via the appropriate series of communication links and routers. In the case in which a domain name is entered, the name is resolved to IP addresses via a Domain Name System (“DNS”) and then routed to the appropriate series of communication links and routers. In response to the received packet information, the server 28, 30 transmits the requested data to the consumer terminal 10 via one or more series of communication links and routers.

However, as discussed in the background section, transmitting a request packet to the web site address that contains the desired product information may include keyboard entry of the address if it is available on the product or associated marketing literature, keyboard entry of a domain name, or use of the key word search through a search service. These methods are very inconvenient for the consumer. Maximizing the convenience will result in maximizing user utilization of such information retrieval functionality.

To make a more consumer friendly system for obtaining web site data associated with a consumer product, Mapping Service Provider (“MSP”) circuitry 64 is suitably connected to the Internet via router 62 and communication link 50. The MSP 64 will typically be a computer functioning as a web server with a mapping program database. The database will suitably include a list of data corresponding to Universal Product Codes and a list of web site addresses associated with each code.

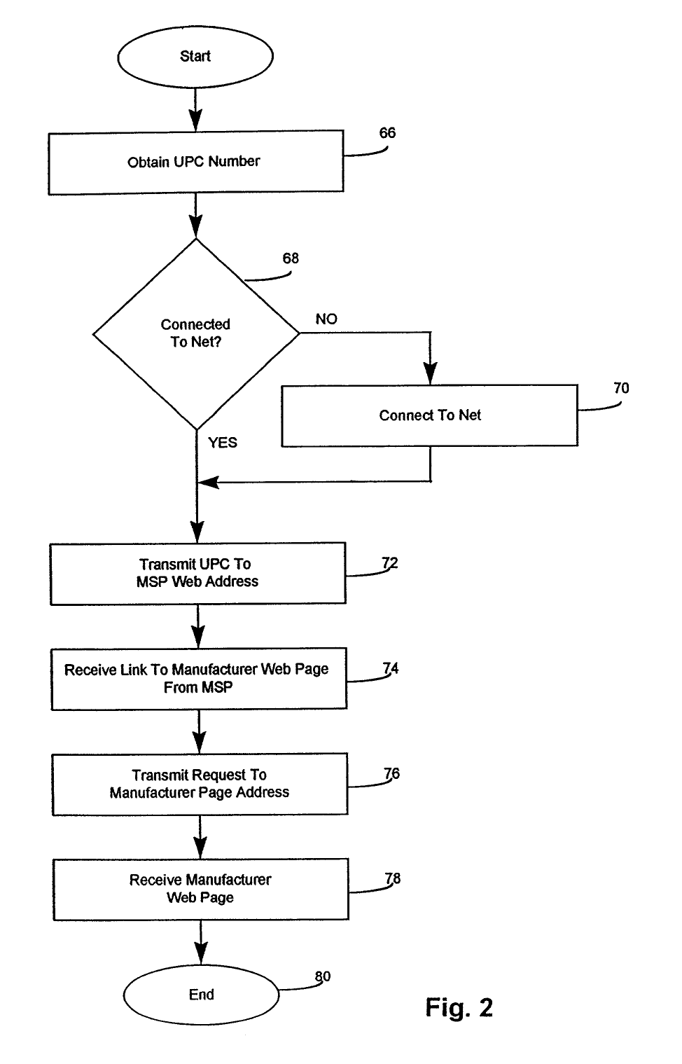

FIG. 2 is a flowchart describing operation of the customer terminal 10 to access product information associated with a product by use of the MSP. Box 66 represents a step of obtaining the UPC code associated, or other indicia, associated with the product. This is suitably entered into the customer terminal by use of bar code reader 16 or keyboard 18. Step 68 represents a test of whether a customer terminal 10 is connected to the Internet. If the consumer has a permanent connection, the answer will always be a yes. However, if the consumer has a dial-in connection, the answer will depend on whether the dial-in connection exists at the time. If not, step 70 represents connecting to the network.

Step 72 represents transmitting TCP/IP packet information to the MSP. Such packet information includes a field containing the UPC code and a field instructing the server to launch the mapping program. Step 74 represents receipt of TCP/IP packet information back from the MSP. In the preferred embodiment, such packet information will be an HTML page information, which information suitably includes a link to the web site address which contains the desired product information. The page will also advantageously include timer information so that the consumer terminal software may automatically execute that link after a predetermined period of time and generate TCP/IP packet information addressed to the web site at step 76. Step 78 represents receipt of the web page with the desired product information and the system ends at step 80.

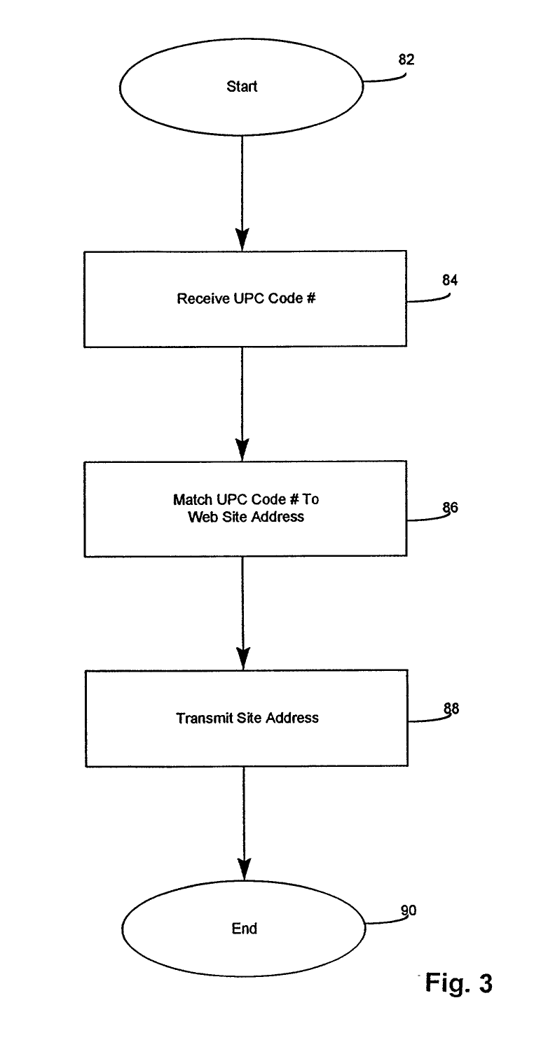

FIG. 3 represents the processing steps performed by the MSP. The system starts at 82 which occurs when the server receives TCP/IP packet information with instructions to launch the mapping program. Step 84 represents reading the UPC code from the appropriate field and step 86 represents matching the UPC code to a web site address in the database. Step 88 represents transmitting TCP/IP packet information back to the consumer terminal which, as discussed previously, advantageously includes a link to the web site with the desired product information.

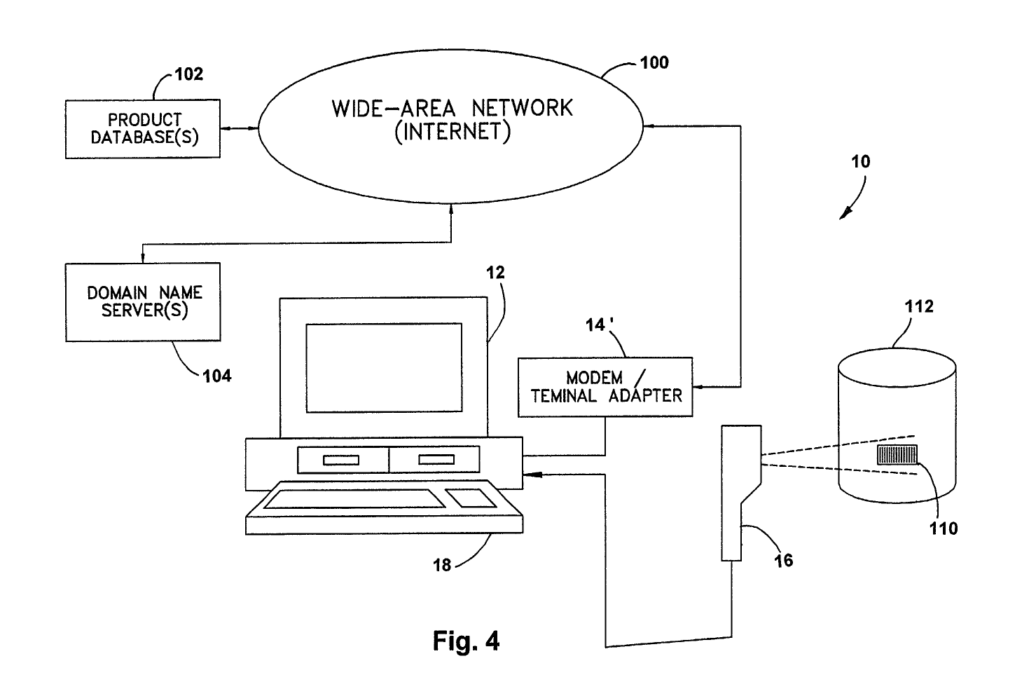

Turning now to FIG. 4, illustrated is a system diagram of the system of the present invention. The user terminal 10 is shown in data communication to a wide area network 100, which is formed from the global Internet in the preferred embodiment. In the diagram of FIG. 4, the Internet connection circuitry 14 is illustrated to be a modem or terminal adapter 14′. The illustration of FIG. 4 also provides an alternative embodiment in which a product database or databases 102 is provided itself with a mapping function between UPC information and product information. One or more domain name servers 104 would allow for a direct translation of an IP address inherent in the UPC product information, to allow for access of product information from a product database 102. Such alternate embodiments allow for each provider or a product database to itself provide a mapping function. Alternatively, such mapping function may be inherent in the information provided in the UPC identifier, such as that evidenced by the UPC code 110 on an associated product 112. In another variation, such mapping information is suitably itself provided in a local storage of the user terminal 10, and accessed via correlation or mapping done at the user terminal. This is suitably done with the database which is periodically updated on the user terminal. Such updating is suitably done manually, by the user, or in an automated fashion, such as with implementation of a JAVA script program suitably provided to the user terminal 10 via the global Internet.

As will be appreciated by one of ordinary skill in the art, the packet-based system employed by TCP/IP systems, such as that used with the global Internet, provides detailed routing information associated with every product inquiry. Therefore, since the packet information must be obtained pursuant to a query and routed to the querying destination, each request inherently includes information about the destination computer. Using cross-application of the DNS system, such IP mapping information is suitably translated to a destination Internet address and/or domain name to allow obtaining of demographic information associated with each query. Such demographic information provides an invaluable resource to the product manufacturer to determine the scope of queries, geographic location of such queries, and even a particular person initiating such queries. This allows for targeted marketing, follow-up information, such as with additional e-mails for product announcements, or even provide a saleable product of demographic information itself. In addition, manufacturers can advantageously share such information to glean valuable market information in a synergetic way.

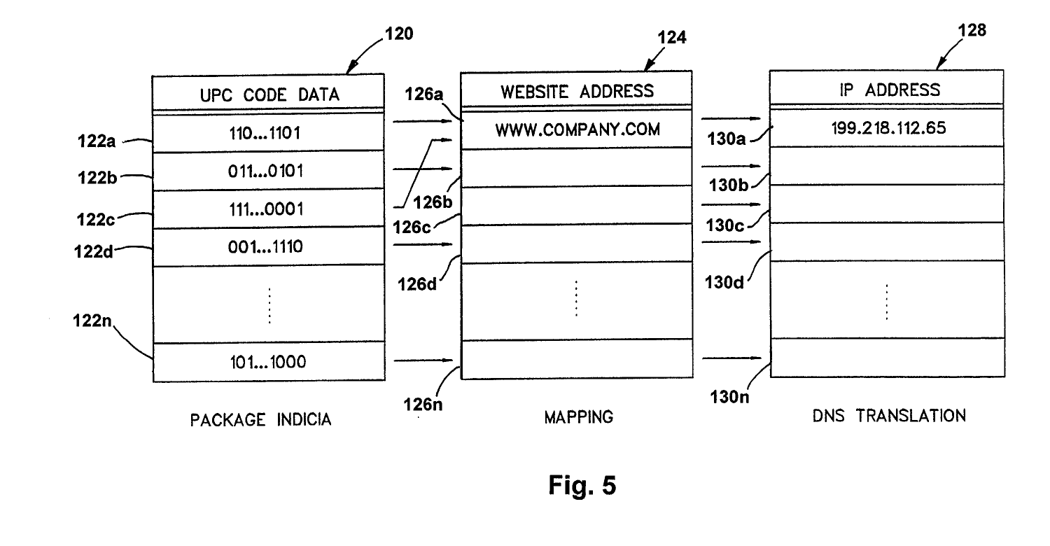

Turning now to FIG. 5, illustrated is the data translation scheme of the subject invention which allows for information gleaned from package indicia to ultimately result in data sufficient to allow for an end user to connect to a manufacturer 's database, such as a selected Internet site. Area 120 illustrates information which is gleaned from packaged indicia, such as UPC code data. A plurality of example codes 128a, 128b, . . . , 128n are listed. A binary representation is provided for each to correspond to the preferred embodiment.

The product data disposed in the area 120 corresponds with an address, such as an Internet address, from which a mapping function is derived as noted above. As evidenced in FIG. 5, there is a corresponding relationship between each product code 122 and corresponding web site address or name 126a, 126b, . . . , 126n. As will be noted, there is not necessarily a one-to-one correspondence between product codes and web site information, as is expected that more than one product code will correspond to a single web site.

As noted earlier, correspondence between the product codes at 120 and the web site information at 124 can be accomplished by separate mapping server 64 (FIG. 1), or is suitably accomplished by local intelligence provided at an individual user 's computer.

Block 128 illustrates an IP address which is used for current Internet addressing schemes. The conventional system of domain name servers provide for hierarchical translation between URLs and IP addresses, currently 32 bytes. As noted above, there also may be a direct correlation between product code information and IP addressing which would provide a direct mapping between the information and blocks 120 and that of 128. Additionally, this may be accomplished by mapping servers, DNS servers, or local intelligence as noted above.

The invention has been described with reference to the preferred and alternate embodiments. Obviously, modifications and alterations will occur to others upon a reading and understanding of this specification. It is intended to include all such modifications and alterations insofar as they come within the scope of the appended claims or the equivalents thereof.

Having thus described the invention, it is now claimed:

1. A method of capturing and providing demographic information concerning a consumer of products to the manufacturer of such products during transactions in which the consumer utilizes a bar code reader and the Internet for product inquiries, comprising:
providing the consumer with a bar code symbol reader;
scanning a uniform product code (UPC) bar code symbol on a product by the consumer;
providing an association table in a database between the UPC symbol data and an Internet web site address affiliated with the product manufacturer;
providing the associated web site address to a computing device of the consumer for allowing the consumer to make a product information inquiry to said web site address; and
providing demographic information about the consumer to the product manufacturer by utilizing the information inquiry.

2. A method as defined in claim 1, wherein the bar code symbol reader is provided in the consumer's home.

3. A method as defined in claim 1, wherein the demographic information includes the geographic location of the consumer.

4. A method as defined in claim 1, wherein further comprising providing targeted e-mails to the consumer for product announcements by the manufacturer.
